(19) United States
(12) Patent Application Publication
(10) Pub. No.: US 2005/0197178 A1
(43) Pub. Date: Sep. 8, 2005

(54) Gun-shaped game controller

(76) Inventor: Ariel P. Villegas, Portland, OR (US)

Correspondence Address: Law Office of Steven B. Leavitt, 9914 Waterview Parkway, Rowlett, TX, 75089, US

(21) Appl. No.: 10/792,226

(22) Filed: Mar. 3, 2004

(51) Int. Cl. A63F 13/00

(52) U.S. Cl. 463/5

(57) ABSTRACT

A firearm shaped game controller for playing an interactive video game has a shape of a gun that communicates with a gaming system that operates the video game having a handle, trigger, and barrel. The gun is fired when the actuation of the trigger simulates firing of the gun. A player may utilize a movement controller provided on an exterior portion of the gun for controlling the movement of at least one game character depicted in the video game. A targeting controller is provided within the gun for aiming the gun at targets depicted in the video game on a monitor in communication with the game system. Advantageously, the plurality of controller buttons affixed along the side of the gun for controlling actions of the game character such that actuation of the controller buttons does not substantially interfere with operation of the movement controller and targeting controller.

### BACKGROUND OF THE INVENTION

1. Technical Field

The present invention relates to a gaming controller. More particularly, the invention relates to a firearm-shaped gaming controller having selection buttons and character movement controls strategically positioned on the controller.

2. Description of Related Art

In the video gaming industry, conventional computer games are known to use a variety of gaming controllers which allow a player to move and operate a game character in a desired fashion. As computer technology develops in the video gaming area, games are becoming more sophisticated in context. Whereas early video games primarily allowed a player to move within a scripted series of video images, today's games are becoming more interactive allowing a player to simulate action within a three dimensional space.

Common gaming controllers, especially for home use, employ a handheld platform having numerous control buttons, directional pads, and/or joysticks positioned on an essentially planar surface. Such platform controllers are commonly used with gaming systems such as X-BOX which is made by MICROSOFT Corporation (Redmond, Wash.) and PLAYSTATION which is made by SONY Corporation (Tokyo, Japan). While this type of controller may suit a plurality of games, many games employing a game character that is principally moving and shooting a simulated firearm do not closely approximate a realistic experience. Essentially, a handheld platform does not simulate a firearm well. A player using a platform controller for certain types of games involving the simulated use of firearms will not have a realistic experience. A player using a firearm, specifically a gun-shaped controller, though will have a more realistic experience.

While game controllers in the shape of firearms are known, they have mostly been used in non-interactive gaming scenarios. Usually, gun-shaped controllers have been used with scripted video images. In applying a gun-shaped controller to an interactive gaming scenario has been difficult.

Essentially, a gun-shaped controller employing the control features of the planar controller has been problematic. Gun-shaped controllers are awkward to use because certain buttons, directional pads, and/or joysticks are not conveniently disposed on the controller. What is needed is a newly designed gun-shaped controller that is efficiently and ergonomically designed to provide a player using the controller a more realistic game experience.

### SUMMARY OF THE INVENTION

A gaming system controller shaped as a firearm such as a handgun made in accordance with the present invention is provided with advantageous positioning of buttons, joysticks, and other control apparatus. The gun controller simulates the appearance of an actual handgun such as a pistol with the inclusion of barrel, handle, trigger, and trigger guard. The materials used to fabricate the gun controller may be of any known type utilized in standard electronic game controllers including plastic and metal. Preferably, the gun is fabricated so that it can be used with game systems currently being marketed in place of the game systems' standard platform controller.

The gun controller is ergonomically designed such that a player may control a game character's movement and the aiming of the gun controller while actuating other buttons conveniently located on the exterior portion of the gun. The actuation of the other buttons do not substantially interfere with control of the character's movement or the aiming of the gun because of the ergonomic positioning of the trigger, gun handle, buttons, joysticks, and other control apparatus.

In one embodiment, the aiming control is performed with the use of an optical aiming device employed within the barrel of the gun controller. Essentially, as the barrel is pointed toward a target appearing on the screen of the monitor displaying the game, the optical aiming device senses the general position to where the barrel is being aimed. When the player actuates the trigger, the gaming system controlling the game can determine whether the player has hit the target with a shot.

In other embodiments, the aiming control is performed by the movement of a directional pad or joystick conveniently positioned on the exterior of the gun controller. Most preferably, the aiming controller and movement controller are positioned beneath the trigger guard of the gun controller. Thereby, the player may actuate these controllers with fingers or by resting the controller, particularly the movement controller, on top of the hand that is not wrapped around the gun controller handle. When resting the controller, the player may cause the game character to move by pivoting the movement controller with the movement of the gun controller.

Another gun controller made in accordance with the present invention includes a sub-machine gun format. The buttons and controls may then be deployed near where either hand is holding and supporting the sub-machine gun controller. In a preferred embodiment, the forward handle of a sub-machine gun controller may be provided essentially a handle shaped joystick. Thereby, the player, for example, may cause the game character to move within the game by pivoting and moving the forward handle accordingly.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a gun-shaped controller in accordance with the present invention;

FIG. 2 is a perspective view of a second gun-shaped controller in accordance with the present invention;

FIG. 3 is a perspective view of a gun-shaped controller in accordance with the present invention utilizing control pads disposed beneath the trigger housing;

FIG. 4 a perspective view of a second gun-shaped controller in accordance with the present invention utilizing control pads disposed beneath the trigger housing;

FIG. 5 is perspective view of a third gun-shaped controller in accordance with the present invention utilizing control pads disposed beneath the trigger housing;

FIG. 6 is perspective view of another gun-shaped controller utilizing a target tracking system; and

FIG. 7 is a side elevational view of a sub-machine gun-shaped controller made in accordance with the present invention.

### DETAILED DESCRIPTION

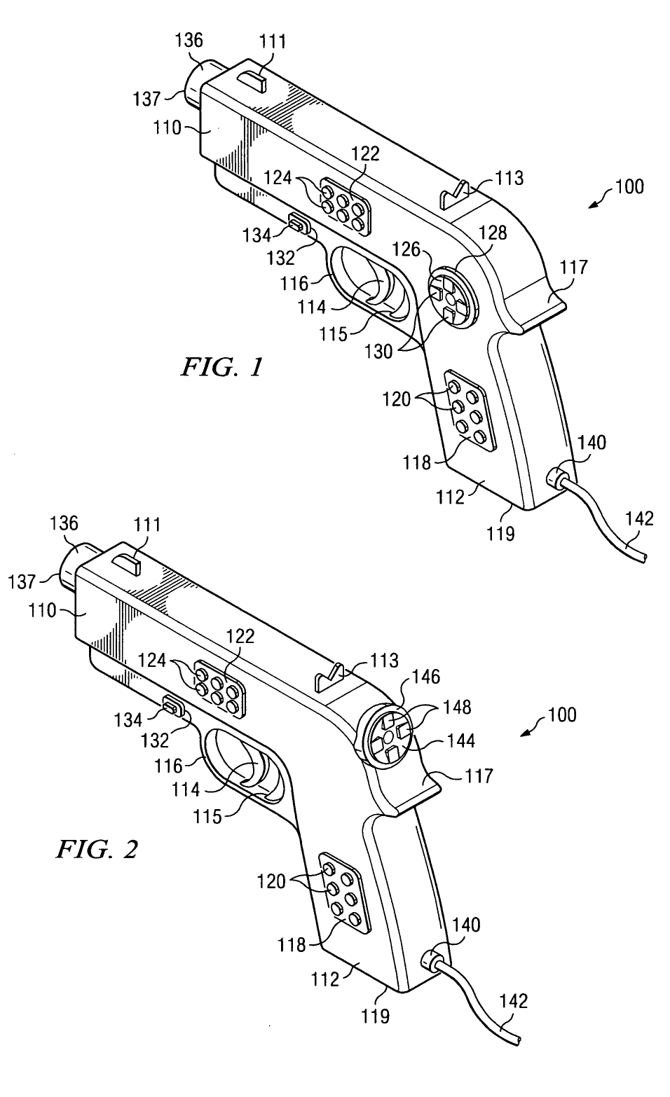

Gun 100, shown in FIGS. 1 and 2, is an embodiment of a game controller made in accordance with the present invention. Therein, gun 100 simulates the appearance of an actual handgun such as a pistol with the inclusion of barrel 110, handle 112, trigger 114, and trigger guard 116. The materials used to fabricate gun 100 may be of any known type utilized in standard electronic game controllers including plastic and metal. Preferably, gun 100 is fabricated so that it can be used with game systems currently being marketed in place of the game systems' standard controller.

As with an actual gun, gun 100 is designed to be held outward with a player's hand when being utilized. In use, gun 100 will be held by a player with one hand positioned about handle 112. Thereby, mock hammer 117 at the end of gun 100 will face the player and muzzle 137 at the front of barrel 110 will be closest to the desired target. To aid in the aiming of gun 100, a forward sight 111 is disposed above and near the terminal end of barrel 110 proximate to muzzle 137, and a rear sight 113 disposed above and near the opposite terminal end of barrel 110.

Several control inputs are provided on handle 112 and barrel 110 for the player to convey instructions the gaming system and its microprocessor operating a game. To allow a player to control features such as having a player's game character jump, change weapons, switch to a different character, punch, kick, use night vision, and the like, gun 100 is designed with a control pad 118 having a plurality of buttons 120. As shown in FIGS. 1 and 2, six buttons 120 are provided on control pad 118 although more or less buttons may be provided depending on the needs of the player to control the game character and the player's game system. Control pad 118 buttons 120 are preferably positioned on the left side of handle 112 for a right-handed player. Thereby, the player may actuate the button with the player's left hand thumb in an efficient and ergonomic manner.

An optional control pad 122 is shown on gun 100 in FIGS. 1 and 2 having control buttons 124. The location of pad 122 is preferably above and about trigger 114 on the left side of barrel 110. This position allows the player's left thumb to actuate buttons 124. Control pad 122 may be provided as in addition to control pad 118 thereby providing the player with a choice as to which control buttons 120 and/or 124 the player finds easier to actuate while playing a game.

Alternatively, buttons 124 may be assigned additional and separate functions to control than buttons 120. This increases the number of control features a player may control without assigning or at least reducing the number of functions assigned to a single button.

In yet another alternative, a single control pad may be provided with gun 100 as a modular piece to be fitted into a corresponding slot located at about where pad 118 and/or pad 122 is shown in FIGS. 1 and 2. The player may then select the location of the control pad according to the player's preference. Any remaining open slots may be sealed with optional covers.

A movement controller 126 is preferably provided on the left side of gun 100 in a location between trigger 114 and mock hammer 117 in FIG. 1. Further, controller 126 is disposed within a pad 128 having optional directional markings 130 disposed about controller 126 in a clock-like fashion. Controller 126 may be a directional pad (“D-pad”), thumbpad, or a joystick that when actuated by a player's thumb or finger, preferably the right thumb, in a desired direction will cause the player's game character to move or appear to move within the game being played. For example, a player may move the character forward, backward, or sideways depending on the game and game system being played.

In addition to having gun 100 simulate a firing with the player's actuation of trigger 114, a secondary weapon button 115 may be provided on gun 100. In FIGS. 1 and 2, button 115 is located proximate to trigger 114 but may be situated in any other practical location on gun 100. Secondary weapon button 115 may be used to have the game character simulate the firing of a secondary weapon such as, for example, a grenade or flame thrower. Button 115 is positioned behind trigger 114 allowing a player to actuate both triggers with the index finger of the hand holding handle 112.

Along barrel 110 a scroll device pad 132 is provided with scroller 134 for selecting options such as zooming, player stance, and/or menu options. Scroller 134 may be a two-way or four-way directional input device depending on the needs of the game system being utilized.

A signal port 140 located along the base of handle 112 receives signal wire 142. Thereby, gun 100 may communicate with the game system and its microprocessor. While signal port 140 is shown at the base of handle 112, other suitable locations may be employed such as at the bottom 119 of handle 112. In an alternative to the hardwire setup of port 140 and wire 142, gun 100 may be fitted with a wireless communication device using infrared or radio signal to convey control instructions from gun 100 to the game system.

Within barrel 110, an optical targeting device 136 is provided. Optical targeting device 136 may be any type similar to those used in prior art video control systems. For example, a photosensor may be incorporated in targeting device 136 within barrel 110. When trigger 114 is actuated by a player, a microprocessor controlling a game can determine approximately where gun 100 is being aimed by causing the screen to emit a white color in the target area. If the photosensor senses the white color within a specific time frame, then the microprocessor can interpret this as a “hit” depending upon the programming of the particular game. Optical targeting systems for video games are disclosed in U.S. Pat. Nos. 4,813,682 and 4,395,045, which are hereby incorporated by reference.

In an alternative embodiment, the optical targeting system of gun 100 utilizes an automated tracking system. Therein, the game system transmits a short pulse that can be sensed by the optical sensing device in gun 100 to the television or monitor employing a raster scan. Depending upon when the scan is sensed by gun 100, the game system can approximate the targeting area at which the player is aiming. The game system continuously transmits intervals of the short pulse which is detected by gun 100 but infrequent enough so that the player cannot detect the pulse or at least not interfere with the player playing the game. Since the game system can approximate where the player is aiming when pointing gun 100 at the screen of the television or monitor, the game system can show a mark or crosshair on the screen to show the player where gun 100 is being aimed. To facilitate turning, if gun 100 is aimed at a designated portion of the television or monitor such as along the left or right edge, the game system can cause the player's character to approximate a turning motion in the corresponding direction.

Regarding the movement of a game character, gun 100 is not limited to having movement control affixed to the side of the gun. Any location of the movement control is within the scope of the present invention providing that it can be easily controlled by a player's thumb or finger while holding gun 100 at or near a television or monitor displaying the video game. In FIG. 2 movement controller 126, pad 128, and optional directional markings 130 have been replaced with movement controller 144, pad 146, and optional directional markings 148. Movement controller 144 may be a D-pad or a joystick and is positioned above mock hammer 117 for easy control by the player's preferred thumb.

While controller 144 is shown positioned along the longitudinal side of gun 100, other alternatives for the position of controller 144 are possible. One position includes providing a platform extending from or about mock hammer 117 from which controller 144 would be positioned facing downward toward the player's hand. The player may then actuate controller 144 with for example the player's right thumb.

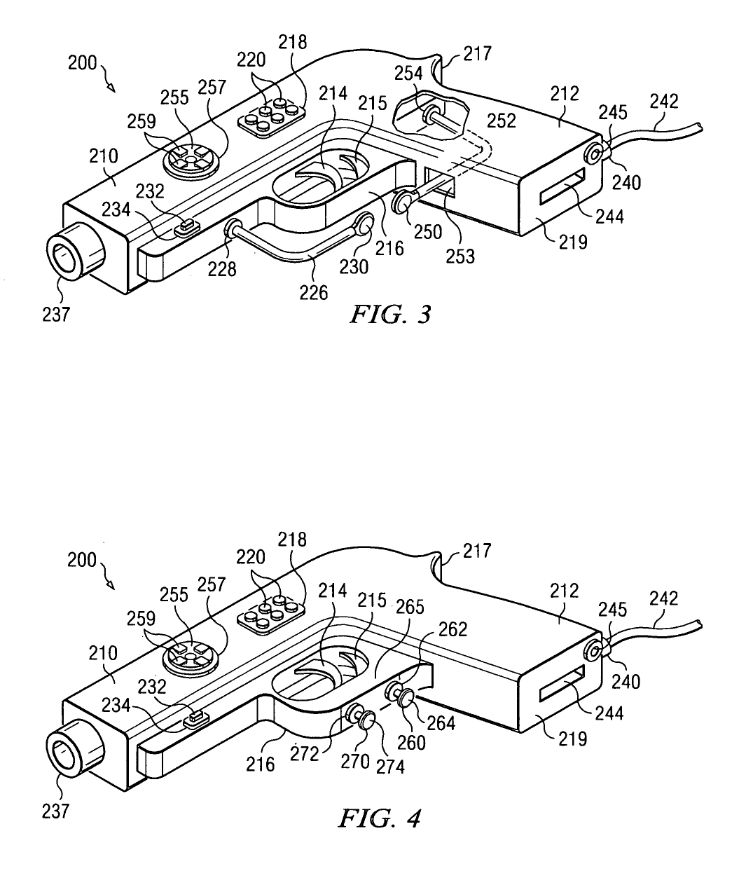

In another embodiment, gun 200 is shown in FIGS. 3-5 employing an aiming and turning device that is actuated by the player using ajoystick, D-pad, thumb pad, or the like. Gun 200 is similar to gun 100 with the exception that an optical targeting device need not be provided within gun 200.

Like gun 100, gun 200 has a barrel 210, a forward sight 211, and a rear sight 213, a handle 212, a trigger 214, a trigger guard 216, a muzzle 237, and a mock hammer 217. Therewith, gun 200 approximates the appearance of a pistol. A secondary weapon trigger 215 may be provided proximate to trigger 214 for the firing of a secondary weapon. On barrel 210, a control pad 218 having a plurality of buttons 220 is provided to allow a player to control game character options such as jumping, changing weapons, switching characters, punching, kicking, using night vision, and the like.

Character movement may be controlled with aiming and turning controller 226 which is L-shaped with the base emanating from socket 228. At the end of controller 226 farthest away from socket 228, a touchpad 230 is provided for the player to actuate controller 226. As shown, controller 226 essentially follows the front outer edge of trigger guard 216. A player may actuate controller 226 by allowing touchpad 230 to rest upon the free hand—the hand that is not holding gun 200 by handle 212.

Aiming and turning of the game character is controlled with directing controller 226 in FIG. 3. Advantageously, the touchpad 230 at the end of controller 226 is positioned beneath trigger guard 216. In use, the player holds gun 200 by handle 212 with, for example, the player's right hand. The player may then rest touchpad 230 on the left hand, which then acts as a pivot point for gun 200.

In an example of actuating controller 226, the player holds gun 200 in the player's right hand with touchpad 230 positioned above the player's left hand. As the player moves gun 200 with the right hand, controller 226 is moved in an opposite direction. If gun 200 is moved toward the right of the player, then controller 226 is moved in an inverted movement toward the left. The electronic component of controller 226 may then send a signal to the microprocessor of the game system indicating the movement of controller 226 toward the left. In response, the game system may then move an aiming point or crosshair being projected onto the television or monitor screen toward the right. When the player has the aiming point or crosshair over the desired location on the screen, the gun may stop being pivoted allowing controller 252 to be set to a neutral position.

Gun 200 also includes several other components. A scroll device pad 232 is provided with scroller 234 for selecting options along barrel 210. Signal port 240, which is located along the base of handle 212, receives signal wire 242. Thereby, gun 200 may be in communication with the game system and its microprocessor. As with gun 100, gun 200 may alternatively relocate port 240 and wire 242 to any viable area on gun 200 to facilitate communication with the game system. Also, gun 200 may substitute a wireless communication device to communicate with the game system. One or more ports 244 and 245 are provided on handle bottom 219 that may be adapted for several uses such as for receiving an optional memory card for the storing of game play, an input/output device for player headset electronics, a communication device for online Internet play, and the like. An alternative location (not shown) for ports 244 is to provide a platform affixed to the bottom of trigger guard 216.

To control movement, a controller 252 is provided emanating from about a middle portion of handle 212 from a socket 254. Further, controller 252 protrudes through opening 253. Like controller 226, controller 252 is L-shaped and has a touchpad 250 that the player may contact to actuate the movement controller 252. Ideally, touchpad 250 is configured to allow the player's middle finger from the hand holding gun 200 by its handle 212 to actuate movement controller 252. Depending on the direction that controller 252 is directed toward, gun 200 will send a signal to the game system to cause the game character to move in accordance.

Gun 200 includes an optional control pad 257 for controlling additional features of the game character, which may include the game character's stance. As a player moves controller 255, which for example may be a D-pad, thumb pad, or joystick, toward a directional indicator 259, the game character may be caused to stand, kneel, or lie down.

As an alternative to having movement controller 226 disposed on gun 200 along barrel 210 or handle 212, controller 226 may be eliminated and replaced with a movement controller affixed in other convenient locations. For example, a movement controller may be positioned under trigger guard 216 in a similar arrangement as controller 260, pad 262, and marking 264 while employing the aiming and turning controller 270, pad 272, and markings 274. Thereby, trigger guard 216 would have a movement controller positioned on the bottom beneath and proximate to the bottom of trigger 214 while also having an aiming and turning controller positioned at the front of trigger guard 216. This layout approximates an L-shape configuration about trigger guard 216. A player may then control a game character's movement by actuating this movement controller with the middle finger of the hand positioned about handle 212.

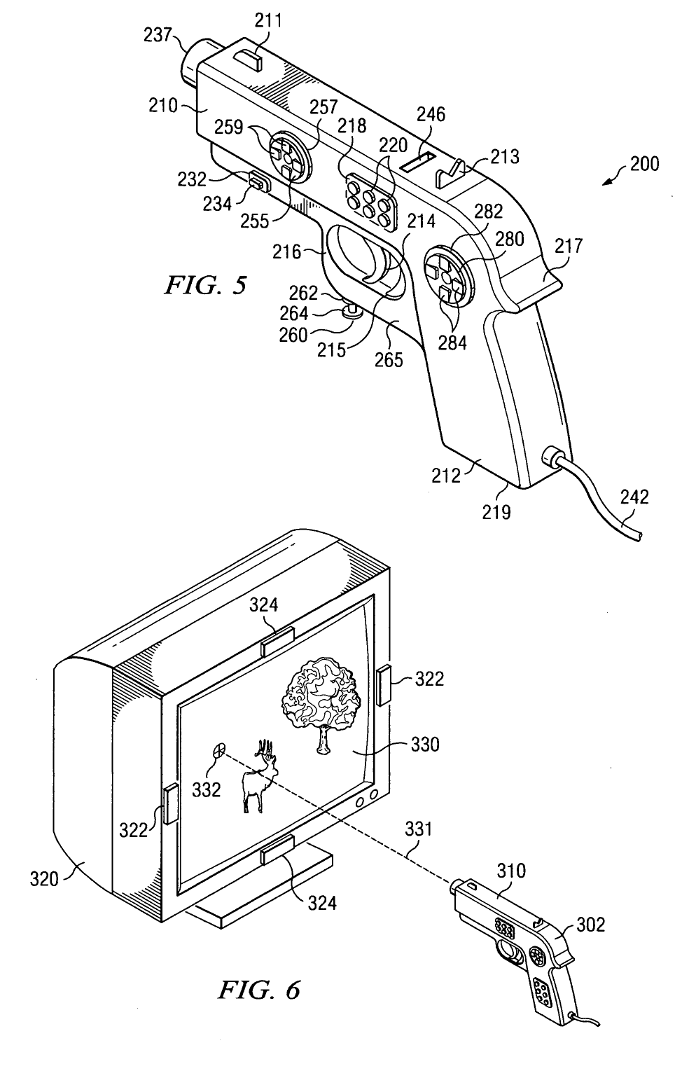

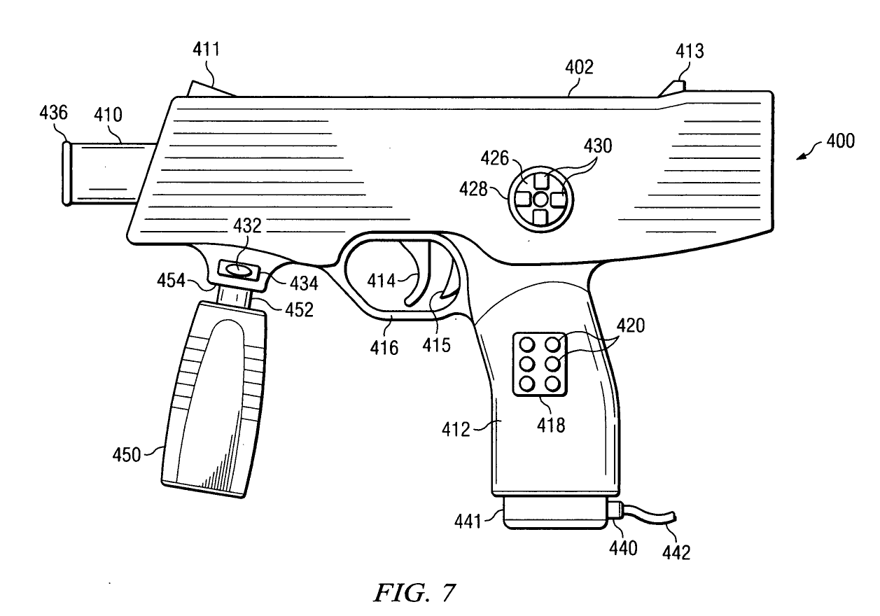

Several examples of alternative positions for the aiming and turning controller and movement controller are shown in FIGS. 4 and 5. In FIG. 4, an aiming and turning short pad controller 260 and pad 262 are located on the bottom of trigger guard 216, on electronics space 265, projecting downward. In this embodiment, a top portion 264 of controller 260 ideally rests upon the free hand and is actuated in a similar manner as touchpad 230. Along the front portion of trigger guard 216, a movement controller 270 is provided and emanates from a pad 272 with directional markings 274. Pad 272 is affixed to the exterior portion of trigger guard 216. In this configuration, a player may actuate controller 270 with a finger from the free hand. In an alternative embodiment, controller 260 may be a directional pad similar to controller 270.

In FIG. 5, movement controller 270, pad 272, and markings 274 have been replaced with controller 280, pad 282, and markings 284. Pad 282 is affixed to the side of handle 212 at about a middle point between mock hammer 217 and secondary trigger 215.

In an alternative movement scheme, the player may control the aiming and turning by using a finger or thumb to actuate controller 260, which is positioned on the bottom of trigger guard 216 in FIG. 4. Unlike the inverted movement above, the movement of controller 260 would produce a standard response. For example, moving controller 260 toward the right would cause the character in the game to move right also. Regardless of the type of movement scheme, the overall movement of controller 260 is preferably kept to a minimum to avoid player fatigue.

Another embodiment of the invention not shown is for the inclusion of an optional video display that may be affixed to the exterior of gun 200 at, for example, video screen port 246 shown in FIG. 5. The optional video display allows for a gun made in accordance with the present invention to be used for mobile gaming, private, or individual use. Therein, the gun may be provided with a folding video display screen, for example a flip-up LCD screen, that is disposed above barrel 210 between sights 211 and 213. The folding video screen may be made for attachment only when the player wishes to utilize it or may be permanently affixed. When a player wishes to use gun 200 in an autonomous mode from any external video screen or television, the player would simply extend the optional video display so that the video display is positioned above barrel 210. For a complete autonomous gaming experience, the game system electronics may be incorporated directly gun 200 including a port installing games or game cartridges, much like a GAME BOY game unit made by NINTENDO Co., Ltd. (Kyoto, Japan).

Another aiming system alternative is shown in FIG. 6 wherein gun 300 remotely controls the aiming and turning of the game character via infrared or radio. Within barrel 310 of gun 300, a transmitter is provided for providing signal(s) to receivers 322 and 324. Receivers 322 and 324 are provided around the periphery of screen 330 of television 320. To measure the horizontal component of movement, a receiver 322 is positioned along the left and right side edges of television 330. To measure the vertical component of movement, a receiver 324 is positioned along the top and bottom edges of television 330. When a player moves gun 300, receivers 322 and 324 detect the movement by sensing whether the signal is becoming stronger or weaker to a particular receiver. Depending on proportional change, an approximate position of where the player is aiming can be determined by the microprocessor of the gaming system. Additionally, an optional target or crosshair 332 can be projected on to screen 330. An imaginary targeting line 331 demonstrates the aiming of gun 300 and the near simultaneous projection of crosshair 331 onto screen 330. When aiming at the screen is not necessary while playing a game, gun 300 may be directed above or below television 320 and receivers 322 may still control the character's turning by sensing whether gun 300 is being pointed toward the left or right of screen 330. Thereby, the player will not become fatigued as easily.

In addition to having the gun of the present invention shaped as a handgun such as gun 100 or 200, a submachine gun format may be employed such as submachine gun 400 shown in FIG. 8. Therein, gun 400 has a main body 402 to which barrel 410, muzzle 436, a rear handle 412, and a forward handle 450 project outward. A primary trigger 414, secondary weapon trigger 415, and a trigger housing 416, which surrounds triggers 414 and 415, are disposed beneath barrel 410 between handles 412 and 450 along the bottom edge of stock 410. Along the top edge of gun 400 are a forward sight 411 and rear sight 413 projecting upward to aid the player in aiming gun 400 at a desired target.

To control features of the game, numerous control inputs are provided for the player to operate on the surface of gun 400. On rear handle 412, a control pad 418 having a plurality of buttons 420 is provided on control pad 418 to allow a player to control game character options such as jumping, changing weapons, switching characters, punching, kicking, using night vision, and the like. Character movement may be controlled with movement controller 426 that is disposed on movement controller pad 428 having optional directional markings 430. Controller 426 as shown may be disposed proximate to mock trigger 417. A scroll device pad 432 is provided with scroller 434 for selecting options along the side of barrel 410.

For communication with the game system and its microprocessor, gun 400 is provided with a signal port 440 located at the rear of mock ammunition clip 441 projecting outward from the base of rear handle 412 receives signal wire 442. As with guns 100, 200, and 300, port 440 and wire 442 may be alternatively positioned at any viable area on gun 400 to facilitate communication with the game system. Also, gun 400 may substitute a wireless communication device to communicate with the game system.

In a preferred embodiment, forward handle 450 is moveable via forward handle connector 452 relative to forward handle receptacle 454 in body 402. Handle 450 may be provided so as to move in multiple directions including forward, backward, toward the left or right of body 402, and directions there between. While playing a game, a player holds gun 400 with a stationary handle 412 and may actuate handle 450 relative to the pivot point formed at receptacle 454. In one embodiment, a player may control weapon aiming and character turning by moving handle 450 in a desired direction.

A further use of moveable handle 450 may be realized with the use of an optical aiming and turning system as set forth for guns 100, 200, and 300. An optical aiming system may be provided in gun 400 in barrel 410 with the optical sensor positioned at about muzzle 436. Handle 450 is then assigned to control the game character's movement as an alternative or replacement for movement controller 426 and movement controller pad 428.

While guns 100, 200, and 300 are shown with all control features being disposed on the left side of the devices for right-handed players, it should be understood that guns 100, 200, and 300 can be manufactured for left-handed players simply by switching the control features to the right side. One embodiment of the invention not shown is to provide the control features as separate modules that may be affixed to respective receptacles provided on guns 100, 200, and 300. The modules may be inserted prior to using guns 100, 200, or 300 by the player according to the player's preferences. To cover the open receptacles, fitted plates may be provided to attach to the openings if desired.

Advantageously, the game control devices of the present invention allow a player to control movement and the aiming and turning of the game character and its weapon. This is an improvement over standard games employing a gun-like controller. These types of standard games typically allow a player to control only the aiming and targeting of the game character's weapon. With a gun of the present invention, a player will be able to play a game that would be otherwise be played using a standard two-hand controller such as those used with PLAYSTATION made by SONY Corporation (Tokyo, Japan) or X-BOX made by MICROSOFT Corporation (Redmond, Wash.). Thereby, a player may experience a more realistic gaming experience when playing shooting type games.

Furthermore, the present invention has applications beyond entertainment purposes. With the advantageous control features, guns in accordance with the present invention may be used by the police and military in order to simulate shooting situations. This may provide personnel with experience and education without the need to provide a full-scale simulation or war game.

While the invention has been particularly shown and described with reference to a preferred embodiment, it will be understood by those skilled in the art that various changes in form and detail may be made therein without departing from the spirit and scope of the invention.

1. A firearm shaped game controller for playing an interactive video game, comprising:
a gun in communication with a gaming system operating the video game having a handle, trigger, and barrel whereby an actuation of the trigger simulates firing of the gun;
a movement controller provided on an exterior portion of the gun for controlling the movement of at least one game character depicted in the video game;
a targeting controller incorporated into the gun for aiming the gun at targets depicted in the video game on a monitor in communication with the game system; and
a plurality of controller buttons affixed to a side of the gun for controlling actions of the game character wherein the controller buttons are positioned on the exterior of the gun such that actuation of the controller buttons does not substantially interfere with operation of the movement controller and targeting controller.

2. The firearm shaped game controller of claim 1 wherein the movement controller is positioned on a planar side of the gun proximate to the trigger.

3. The firearm shaped game controller of claim 1 wherein the movement controller is positioned on a top segment of the gun proximate to a terminal end of the barrel adjacent to the handle.

4. The firearm shaped game controller of claim 1 wherein the targeting controller is an optical aiming device.

5. The firearm shaped game controller of claim 1 wherein the targeting controller employs electromagnetic radiation that emanate from the gun which are received by sensors disposed about the monitor.

6. The firearm shaped game controller of claim 1 wherein the gun further comprises a secondary trigger proximate to the trigger.

7. The firearm shaped game controller of claim 1 wherein the movement controller for controlling the movement depends outward from the gun and has a terminal end positioned beneath the gun for actuation by a player.

8. The firearm shaped game controller of claim 1 wherein the targeting controller for controlling the targeting depends outward from the gun and has a terminal end positioned beneath the gun for actuation by a player.

9. The firearm shaped game controller of claim 1 wherein the targeting controller depends outward from the gun and has a terminal end for actuation by a player in front of the trigger housing and has a terminal end proximate to the trigger housing for actuation by a player.

10. A firearm shaped game controller for playing an interactive video game, comprising:
a gun in communication with a gaming system operating the video game having a handle, trigger, and barrel whereby an actuation of the trigger simulates firing of the gun;
a movement controller for controlling the movement of at least one game character depicted in the video game is disposed beneath a trigger guard;
a targeting controller disposed beneath the trigger guard for aiming the gun at targets depicted in the video game on a monitor in communication with the game system; and
a plurality of controller buttons affixed to a side of the gun for controlling actions of the game character wherein the controller buttons are positioned on the exterior of the gun such that actuation of the controller buttons does not substantially interfere with operation of the movement controller and targeting controller.

11. The firearm shaped game controller of claim 7 wherein the targeting controller depends from about a bottom segment of the barrel disposed in front of the trigger housing and has a terminal end proximate to the trigger housing for actuation by a player.

12. The firearm shaped game controller of claim 7 wherein the movement controller depends outward from the handle and has a terminal end for actuation by a player.

13. The firearm shaped game controller of claim 7 wherein the movement controller and targeting controller depend from the trigger guard.

14. The firearm shaped game controller of claim 7 wherein the gun further comprises at least one input slot for receiving a memory card, audio input, or an attachable video monitor.

15. A firearm shaped game controller for playing an interactive video game, comprising:
a gun in communication with a gaming system operating the video game having a forward handle, a rear handle, trigger, and barrel whereby an actuation of the trigger simulates firing of the gun;
a movement controller for controlling the movement of at least one game character depicted in the video game is controlled by movement of the forward hadle;
a targeting controller disposed beneath the trigger guard for aiming the gun at targets depicted in the video game on a monitor in communication with the game system; and
a plurality of controller buttons affixed to a side of the gun for controlling actions of the game character wherein the controller buttons are positioned on the exterior of the gun such that actuation of the controller buttons does not substantially interfere with operation of the movement controller and targeting controller.

16. The firearm shaped game controller of claim 15 wherein the forward handle is pivoted relative to the barrel to effect movement of the character in the game.

17. The firearm shaped controller of claim 15 wherein the gun has a shape of a sub-machine gun.

18. The method of using the firearm shaped controller of claim 1 wherein a player using the gun may depress other buttons affixed on the exterior of the gun while simultaneously.

19. The method of using the firearm shaped controller of claim 7 wherein a player using the gun may depress other buttons affixed on the exterior of the gun while simultaneously.

20. The method of using the firearm shaped controller of claim 15 wherein a player using the gun may depress other buttons affixed on the exterior of the gun while simultaneously.
